(19) United States
(12) Patent Application Publication
(10) Pub. No.: US 2025/0043040 A1
(43) Pub. Date: Feb. 6, 2025

(54) DIENE RUBBERS PREPARED WITH UNSATURATED SILOXANE-BASED COUPLING AGENTS

(71) Applicant: ARLANXEO DEUTSCHLAND GMBH, Dormagen (DE)

(72) Inventor: Kilian Nikolaus Richard WUEST, Dormagen (DE)

(73) Assignee: ARLANXEO DEUTSCHLAND GMBH, Dormagen (DE)

(21) Appl. No.: 18/717,364

(22) PCT Filed: Dec. 6, 2022
(86) PCT No.: PCT/EP2022/084576

§ 371 Date: Jun. 6, 2024

(30) Foreign Application Priority Data
Dec. 7, 2021 (EP) 21212860.7

(51) Int. Cl. C08F 8/42; B60C 1/00; C08G 77/442

(52) U.S. Cl. CPC C08F 8/42; B60C 1/0016; C08G 77/442

(57) ABSTRACT

Method of making a polydiene rubber comprising
(i) polymerizing at least one aliphatic conjugated diene monomer, preferably having from 4 to 25 carbon atoms, to produce polymers having reactive polymer chain ends,
(ii) reacting at least some of the reactive polymer chain ends with a coupling agent comprising from 2 to 20 unsaturated siloxane units, preferably from 3 to 15 units, more preferably from 3 to 10 units.

Also provided are polydiene rubbers obtained by the method, curable compositions comprising the polydiene rubber and composition comprising the cured polydiene rubber.

### BACKGROUND

Diene rubbers are widely used as a raw material for producing tires. Coupling agents may be used for improving diene rubber processing. Coupling agents link the polymer chains of the rubbers with each other to create a branched or star-shaped polymer architecture. This leads to a broader molecular weight distribution of the polymers and reduces the Mooney viscosity of compounds containing them and facilitates their processing. Examples of known coupling reagents include silicon tetrachloride, methyltrichlorosilane, dimethyldichlorosilane, tin tetrachloride, dibutyltin dichloride, tetraalkoxysilanes, derivatives of ethylene glycol diglycidyl ether, 1,2,4-tris(chloromethyl)benzene. In US2005/0107541A1 the use of a substituted silasesqquioxane, a polycyclic substituted polysiloxane, as a coupling agent is reported. However, there is a need to provide alternative coupling agents for coupling diene rubbers.

### SUMMARY

Therefore, in one aspect there is provided a method of making a polydiene rubber comprising
(i) polymerizing at least one aliphatic conjugated diene monomer to produce a polymer having reactive polymer chain ends,
(ii) reacting at least some of the reactive polymer chain ends with a coupling agent comprising from 2 to 20 unsaturated siloxane units, wherein the coupling agent comprises a cyclic structure having at least two unsatured siloxane units but wherein the coupling agent is not polycyclic.

In another aspect there is provided a polydiene rubber obtained by the method above.

In a further aspect there is provided a curable composition comprising the polydiene rubber and further comprising at least one vulcanisation agent for curing the polydiene rubber.

In yet another aspect there is provided a composition comprising a cured polydiene rubber obtained by curing the curable composition.

### DETAILED DESCRIPTION

The present disclosure will be further illustrated in the following detailed description.

In the following description certain standards (ASTM, DIN, ISO etc) may be referred to. If not indicated otherwise, the standards are used in the version that was in force on Mar. 1, 2020. If no version was in force at that date because, for example, the standard has expired, then the version is referred to that was in force at a date that is closest to Mar. 1, 2020.

All documents recited in this description are incorporated by reference, unless indicated otherwise.

In the following description the amounts of ingredients of a composition or a polymer may be indicated interchangeably by “weight percent”, “wt. %” or “% by weight”. The terms “weight percent”, “wt. %” or “% by weight” are based on the total weight of the composition or polymer, respectively, which is 100% unless indicated otherwise.

The term “phr” means “parts per hundred parts of rubber”, i.e., the weight percentage of an ingredient of a composition containing one or more rubber is based on the total amount of rubber which is set to 100% by weight. Therefore, total weight of the composition is usually greater than the amount of rubber and can be greater than 100% by weight.

Ranges identified in this disclosure are meant to include and disclose all values between the endpoints of the range and its end points, unless stated otherwise.

The term “comprising” is used in an open, non-limiting meaning. The phrase “a composition comprising ingredients A and B” is meant to include ingredients A and B but the composition may also have other ingredients. Contrary to the use of “comprising” the word “consisting” is used in a narrow, limiting meaning. The phrase “a composition consisting of ingredients A and B” is meant to describe a composition of ingredients A and B and no other ingredients.

### Siloxane-Based Coupling Agents

The coupling agents according to the present disclosure contain at least 2 unsaturated siloxane units, preferably at least 2 to 20, more preferably from 3 to 15 and most preferably from 4 to 10 unsaturated siloxane units. Therefore, coupling agents according to the present disclosure contain, in addition to —Si—O— units, at least two, preferably at least three, more preferably at least four units having at least one carbon-carbon double bond, preferably vinyl groups (—CH═CH₂ groups). Typically, these units are connected to the silicon atom of the Si—O— unit. Therefore, these units are referred to herein as “unsaturated siloxane units” or “unsaturated —Si—O units”. The coupling agents may be linear or branched or cyclic but not polycyclic. Preferably they are cyclic, and preferably they have at least one cyclic structure, preferably a cyclic siloxane structure, i.e., a cyclic structure containing at least one unsaturated —Si—O— unit as described above. Preferably, the siloxane-based coupling agents are cyclic and have a cyclic structure with at least two unsaturated siloxane units, more preferably at least three unsaturated siloxane units.

The coupling agents according to the present disclosure preferably are used to couple polydiene rubbers, i.e., to link polymer chains with each other, preferably to create branched, for example multi-armed or star-shaped polymer architectures. The polymer coupling can be observed by an increase of molecular weight measured for example by GPC. The degree of coupling can be determined by comparing the chromatogram of the coupled polymer to the chromatogram of its precursor polymer. Upon coupling a high molecular weight fraction appears in the chromatogram. The ratio of the integral of the coupled fraction to the integral of the whole molecular weight distribution is the degree of coupling (weight % of polymer which is coupled).

An advantage of using the coupling agents according to the present disclosure in the production of polydiene rubbers is that they allow to fine-tune the polymer structure. When the siloxane-based reagents are used in molar excess of their unsaturated units, with respect to polymer chains, the coupled polymer may contain unreacted unsaturated units from the coupling agent that may participate in a cross-linking (vulcanization) reaction. However, if the presence of unsaturated groups from the coupling agent in the polymer is not desired, their presence can be avoided or reduced by using the coupling agents in equimolar or submolar amounts (based on the molar ratio of unsaturated units of the coupling agent to polymer chains). In this case all unsaturated units of the coupling reagent can be expected to have been consumed by the coupling reaction. The molar amount of reactive polymer chains produced in the polymerization reaction can be assumed to be equivalent to the molar amount of polymerization initiator used in the polymerization reaction.

The coupling agent according to the present disclosure comprises from 2 to 20 unsaturated siloxane units, preferably from 3 to 15 unsaturated siloxane units, more preferably from 4 to 10 unsaturated siloxane units, corresponding to the general formula (1):

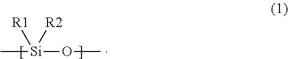

In formula (1) each R1 independently represents an alkenyl group, preferably selected from the group consisting of vinyl (—CH═CH₂), allyl (—CH—CH₂—CH═CH₂), n-propenyl (—CH₂CH═CH₂), n-butenyl (—CH₂CH₂CH═CH₂), isobutenyl (—CH₂(CH₃)CH═CH₂); n-pentenyl (—CH₂CH₂CH₂CH═CH₂), isopentenyl (—CH₂(CH₃)CH₂CH═CH₂, —CH₂CH₂(CH₃)CH═CH₂) and each R2 independently represents H, OH, or an organic residue, preferably having from 1 to 20 carbon atoms, and, optionally having one more heteroatoms selected from O, S, Si, N and a combination thereof. The hydrocarbon residue may be unsubstituted or substituted, where at least one hydrogen atom has been replaced by a substituent. Suitable substituents include siloxanes, polysiloxanes, silyls, aminosilyls, aminosiloxanes, alkylamino-groups, halogens and combinations thereof. Preferably, the hydrocarbon residue is aliphatic. Preferably, the hydrocarbon residue is selected from an alkenyl, preferably having from 2 to 10 carbon atoms, an alkyl preferably having from 1 to 10 carbon atoms, wherein the alkyl or alkenyl chain or both may be interrupted once or more than once by an ether oxygen atom, or R2 is selected from a siloxane or polysiloxane with up to 10 silicon atoms wherein the siloxane or polysiloxane may, optionally, have at least one silicone atom having at least one aliphatic substituent selected from alkyl, alkylene or alkenyl groups or a combination thereof. Preferably, at least one R2 represents methyl, or ethyl. Preferably all R2 represent methyl or ethyl or a combination thereof.

In a preferred embodiment of the present disclosure the siloxane-based coupling agent contains at least one, preferably at least two, more preferably at least three units corresponding to the general formula (2):

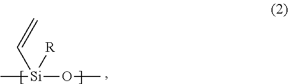

wherein R corresponds to R2 of formula (1) above. Preferably, R is selected from an alkyl having 1 to 10 carbon atoms and that may, optionally contain one more oxygen-ether atoms, and may be an alkoxy or polyalkoxy residue, or may, optionally contain one or more silane-groups, siloxane groups or polysiloxane groups wherein the polysiloxane or siloxane groups may contain from 1 to 3 alkyl or alkenyl residue on the silicon atoms and the maximum number of silicon atoms, preferably, is less than 10. Preferably, R is a C₁-C₁₀-alkyl group, more preferably a C₁-C₇-alkyl group and most preferably R is methyl.

In another preferred embodiment of the present disclosure the unsaturated siloxane coupling agent is cyclic and corresponds to the formula (3)

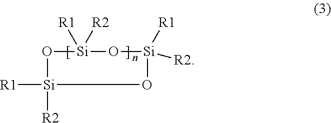

wherein n is 1, 2, 3 or 4, preferably n is 1 or 2, and each R1 is as described in formula (1) and preferably at least one, more preferably all R1 represent a vinyl (—CH═CH₂) group. Each R2 is as described in formula (1) above. Preferably at least one R2 is a C₁-C₇-alkyl group and more preferably at least one R2 is methyl. Most preferably all R2 represent a methyl group.

In one embodiment of the present disclosure the unsaturated siloxane coupling agent corresponds to the general formula (4):

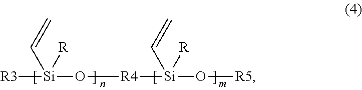

wherein n is an integer of 1 to 20 and m is integer of 1 to 20, and each residue R is selected independently from each other and is as described for formula (2) above, and

R3 is H, OH, a saturated or unsaturated hydrocarbon with 1 to 10 carbon atoms, a monovalent siloxane, polysiloxane or silane, or R3 connects to R5 to form a cyclic compound and represents a bivalent siloxane or polysiloxane with 1 to 10 silicon atoms and wherein one or at least one of the silicon atoms carries one or more alkyl or alkenyl residues having from 1 to 10 carbon atoms, or R3 and R5 jointly form a chemical bond to form a cyclic compound, and

R4 is a linker group selected from (i) aliphatic hydrocarbons having from 1 to 20 carbon atoms that may optionally contain one or more oxygen ether groups, (ii) one or more silane or siloxane groups or combinations thereof, wherein one or more than one silicon atom may carry one or more aliphatic hydrocarbon groups having from 1 to 10 carbon atoms or a combination of (i) and (ii), and

R5 is H, OH, a saturated or unsaturated hydrocarbon with 1 to 10 carbon atoms, a monovalent siloxane, polysiloxane or silane, or R5 is connected to R3 to form a cyclic compound and represents a bivalent siloxane or polysiloxane with 1 to 10 silicon atoms and wherein one or at least one of the silicon atoms carries one or more alkyl or alkenyl residues having from 1 to 10 carbon atoms, or R5 connects to R3 to form a cyclic compound and represents a bivalent siloxane or polysiloxane with 1 to 10 silicon atoms and wherein one or at least one of the silicon atoms carries one or more alkyl or alkenyl residues having from 1 to 10 carbon atoms, or R3 and R5 jointly form a chemical bond to form a cyclic compound.

Preferably, the coupling agent of the present disclosure is not a polycyclic compound. An embodiment of of a polycyclic compound corresponds to the formula (5):

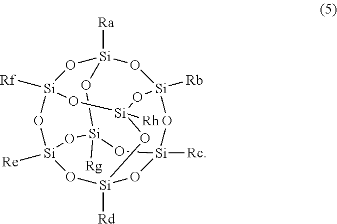

In formula (5) Ra, Rb, Rc, Rd, Re, Rf, Rg and Rh are identical or different from each and are selected independently from each other a C₁-C₁₀-alkyl, a C₂-C₆-alkenyl, a —O—Si—(R_{1′}R_{2′}R_{3′}), wherein R1′, R2′ and R3′ are selected independently from each other from a C₁-C₁₀-alkyl, a C₂-C₆-alkenyl, for example vinyl, for example at least one of R1′, R2′ and R3′ comprises a vinyl unit, or all of R1′, R2‘ and R’3 are vinyl (—CH═CH₂). At least one, or at least two, or at least three of Ra, Rb, Rc, Rd, Re, Rf, Rg and Rh comprises a C₂-C₆-alkenyl, for example a vinyl (—CH═CH₂). In one embodiment of a polycyclic coupling agent according to formula (5) at least four of Ra-Rh are vinyl or at least one of residues Ra-Rh is —O—Si(vinyl)₃. In another embodiment of a compound according to formula (5) all of Ra-Rh are vinyl. Compounds according to formula (5) are also known as polyhedral oligomeric silsesquioxanes or POSS. The materials are commercially available or can be prepared as described, for example, in Quirk, Cheng et al in Macromolecules 2012, 45, 21, 8571-8579.

Preferably, the coupling agent according to the present disclosure has a molecular weight of up to and including 5000 g/mol. Preferably the coupling agent has a molecular weight of less than 2000 g/mol.

Particularly preferred examples of coupling agents according to the present disclosure include 1,3,5,7-tetravinyl-1,3,5,7-tetramethylcyclotetrasiloxane and 1,3,5-trivinyl,1,3,5-trimethylcyclotrisiloxane:

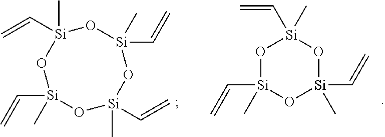

Combinations of one or coupling agents according to the present disclosure may be used also as well as combinations of one or more coupling agents of the present disclosure with one or more other coupling agents.

### Polymers

In one aspect of the present disclosure polymers are provided that can be obtained by a method comprising (i) polymerizing at least one conjugated diene monomer to produce polymers having reactive chain ends and (ii) reacting at least some of the reactive polymer chain ends with at least one of the siloxane-based coupling agents according to the present disclosure. The conjugated diene monomers preferably have from 4 to 25, more preferably from 4 to 20 carbon atoms.

The polymers may be homopolymers or copolymers and comprise units derived from at least one conjugated diene monomer. Suitable diene monomers include but are not limited to 1,3-butadiene, isoprene, 1,3-pentadiene, 2,3-dimethylbutadiene, 1-phenyl-1,3-butadiene, 1,3-hexadiene, myrcene, ocimene, farnesene and combinations thereof. Preferably the polymer comprises units derived from 1,3-butadiene or consists of units derived from 1,3-batdiene.

In one embodiment of the present disclosure the polymer is a copolymer obtained by a method comprising a polymerization reaction comprising at least two conjugated dienes. In another embodiment the present disclosure the polymer is a copolymer obtained by a method comprising polymerizing at least one conjugated diene monomer and at least one vinylaromatic comonomer. Examples of suitable vinyl aromatic comonomers include, but are not limited to, styrene, ortho-methyl styrene, meta-methyl styrene, para-methyl styrene, para-tertbutyl styrene, vinyl naphthalene, divinyl benzene, trivinyl benzene, divinyl naphthalene and combinations thereof. Styrene is particularly preferred.

In one embodiment of the present disclosure the polymers are butadiene polymers and include homopolymers and copolymers of 1,3-butadiene. Preferably, the polymers according to the present disclosure contain at least 51% by weight, preferably at least 60% by weight, based on the weight of the polymer, of units derived from 1,3-butadiene. In one embodiment of the present disclosure the diene polymers contain at least 60% by weight, or at least 75% by weight units derived from 1,3-butadiene.

In one embodiment of the present disclosure the diene polymers contain from 0 to 49% by weight, or from 0% to 40% by weight, based on the total weight of the polymer, of units derived from one or more comonomers.

In one embodiment of the present disclosure the diene polymers contain at least 60% by weight, or at least 70% by weight units derived from 1,3-butadiene and from 0 to 40% by weight, or from 0 to 30% by weight of units derived from one or more comonomers.

In one embodiment the diene polymers of the present disclosure contain from 0 to 20% by weight of units derived from one or more conjugated dienes other than 1,3 butadiene.

In one embodiment the diene polymers according to the present disclosure contain up to 49% by weight of units derived from one or more vinylaromatic comonomer, preferably from 5% to 40% by weight of units derived from one or more vinylaromatic comonomer. Preferably, the diene polymers of the present disclosure contain up to 49% by weight, based on the weight of the polymer, or from 0 to 40% by weight, of units derived from styrene.

In one embodiment the polymer according to the present disclosure comprises at least 75% or at least 95% by weight of units derived from one or more than conjugated diene monomers. In one embodiment the polymer according to the present disclosure comprises from 55% to 92% by weight of units derived from one or more conjugated diene monomers and from 5.8% to 45% by weight of units derived from vinyl aromatic comonomers.

Suitable copolymerizable comonomers further include one or more alpha-olefins, for example, ethene, propene, 1-butene, 1-pentene, 1-hexene, 4-methyl-1-pentene, 1-octene and combinations thereof.

In one embodiment, the diene polymers according to the present disclosure contain from 0 to 20% by weight of units derived from ethene, propene, 1-butene, 1-pentene, 1-hexene, 4-methyl-1-pentene,1-octene and combinations thereof.

Suitable comonomers also include, but are not limited to, one or more other co-polymerizable comonomers that introduce functional groups including cross-linking sites, branching sites, branches or functionalized groups. In one embodiment of the present disclosure the diene polymers contain from 0% to 10% by weight or from 0% to 5% by weight of units derived from one or more of such other comonomers.

Combinations of one or more of the comonomers of the same chemical type as described above as well as combinations of one or more comonomers from different chemical types may be used.

The diene polymers according to the present disclosure may have a Mooney viscosity ML 1+4 at 100° C. of from 10 to 200 Mooney units, for example from 30 to 150 or from 35 to 85 Mooney units.

The diene polymers according to the present disclosure may have a number-averaged molecular weight (Mn) of from 10,000 g/mol to 2,000,000 g/mol, or from 100,000 to 1,000,000 g/mol, for example from 100,000 to 400,000 g/mol or from 200,000 to 300,000 g/mol. In one embodiment of the present disclosure, the polymers have an Mn of from 150 kg/mol to 320 kg/mol.

The diene polymers according to the present disclosure may have a dispersity (also referred to herein as molecular weight distribution or MWD) from 1.03 to 25, for example from 1.03 to 5. In one embodiment of the present disclosure the polymers have an MWD of from 1.03 to 3.5 or from 1.03 to 2.0. The MWD is the ratio of the weight-averaged molecular weight (Mw) to the number averaged molecular weight Mn, i.e., MWD equals Mw/Mn.

The diene polymers according to the present disclosure are rubbers and typically have a glass transition temperature of less than 20° C. They may have a glass transition temperature (Tg), for example, of from −120° C. to less than 20° C. In a preferred embodiment of the present disclosure the polymers have a Tg of from 0° C. to −110° C. or from −10° C. to −80° C. In one embodiment of the present disclosure the butadiene polymer has a glass transition temperature of from about −50 to −80° C.

In one embodiment of the present disclosure the diene polymers have a number-averaged molecular weight of from 100,000 to 1,000,000 and a Mooney viscosity ML 1+4 at 100° C. of from 30 to 150 units and a glass transition temperature of from −110° C. to 0° C.

In one embodiment the diene polymers according to the present disclosure have a Mooney viscosity ML 1+4 at 100° C. of from 30 to 150 units, a number-averaged molecular weight of from 100,000 to 400,000 g/mole, a glass transition temperature of from −110° C. to 0° C. and a molecular weight distribution (MWD) from 1.03 to 20.

The diene polymers according to the present disclosure may be additionally functionalized—and may contain one or more functional group, preferably an end group, containing, in addition to C and H atoms, at least one heteroatom selected from Si, S, N, O and a combination thereof. Such additionally functionalized polymers are obtainable by a reaction comprising reacting the reactive polymer chain ends with at least one functionalization reagent containing, in addition to C and H atoms, at least one heteroatom selected from Si, S, N, O and combinations thereof. The at least one functionalization reagent may be reacted with the polymer before, while or after, preferably after, reacting the polymer with the coupling agent. If necessary, the reaction product of the functionalization reaction may subsequently be treated to generate at least one —OH, —SH or —COOH group or a combination thereof or an anionic form thereof selected from —O⁻, —S⁻, —COO⁻ groups and combinations thereof. Such treatment may include carrying out a hydrolysis reaction, for example by adding an alcohol or an acid, or includes a treatment with at least one other functionalization reagent that reacts with the first functionalization reagent to produce at least one —OH, —SH, or —COOH group or a combination thereof or an anionic form thereof selected from —O⁻, —S⁻, —COO⁻.

### Methods of Making Polymers

The homo- or copolymers of the present disclosure can be prepared by methods known in the art. The polymerization may be carried out to produce a statistical polymer, also called random copolymer, a block-copolymer, a gradient copolymer or combinations of them and include linear and branched architectures as known by the person skilled in the art.

The polymers can be obtained by a process comprising an anionic polymerization or a catalytic polymerization using one or more coordination catalysts. Coordination catalysts in this context include Ziegler-Natta catalysts or monometallic catalyst systems. Preferred coordination catalysts are those based on Ni, Co, Ti, Zr, Nd, V, Gd, Cr, Mo, W or Fe. Preferably the polymerization reaction comprises an anionic solution polymerization. Initiators for anionic solution polymerization include organometals, preferably based on alkali or alkaline earth metals. Examples include but are not limited to methyllithium, ethyllithium, isopropyllithium, n-butyllithium, sec-butyllithium, pentyllithium, n-hexyllithium, cyclohexyllithium, octyllithium, decyl-lithium, 2-(6-lithio-n-hexoxy)tetrahydropyran, 3-(tert-butyldimethylsiloxy)-1-propyllithium, phenyllithium, 4-butylphenyllithium, 1-naphthyllithium, p-toluyllithium and allyllithium compounds, derived from tertiary N-allylamines such as [1-(dimethylamino)-2-propenyl]lithium, [1-[bis(phenylmethyl)amino]-2-propenyl]lithium, [1-(diphenylamino)-2-propenyl]lithium, [1-(1-pyrrolidinyl)-2-propenyl]lithium, lithium amides of secondary amines such as lithium pyrrolidide, lithium piperidide, lithium hexamethylene imide, lithium 1-methyl imidazolidide, lithium 1-methyl piperazide, lithium morpholide, lithium dicyclohexylamide, lithium dibenzyl amide, lithium diphenyl amide. The allyllithium compounds and the lithium amides can also be prepared in situ by reacting an organolithium compound with the respective tertiary N-allylamines or with the respective secondary amines. Di- and polyfunctional organolithium compounds can also be used, for example 1,4-dilithiobutane, dilithium piperazide. Preferably n-butyllithium, sec-butyllithium or a combination thereof are used. The initiator creates anionic, reactive monomers and the polymerization propagates by the reaction of the reactive carbanionic monomers with other monomers which creates reactive carbanionic polymer chain ends. In case of a polymerization using one or more coordination catalysts, the reactive chain ends are produced by the catalyst.

Randomizers and control agents as known in the art can be used in the polymerization for controlling the structure of the polymer, in particular for avoiding aggregations or for increasing random structures. Such agents include, for example, diethyl ether, di-n-propylether, diisopropyl ether, di-n-butylether, ethylene glycol dimethyl ether, ethylene glycol diethyl ether, ethylene glycol di-n-butyl ether, ethylene glycol di-tert-butyl ether, diethylene glycol dimethyl ether, diethylene glycol diethyl ether, diethylene glycol di-n-butyl ether, diethylene glycol di-tert-butyl ether, 2-(2-ethoxyethoxy)-2-methyl-propane, triethylene glycol dimethyl ether, tetrahydrofuran, ethyltetrahydrofurfuryl ether, hexyltetrahydrofurfuryl ether, 2,2-bis(2-tetrahydrofuryl)propane, dioxane, trimethylamine, triethylamine, N,N,N′,N′-tetramethyl-ethylenediamine, N-methylmorpholine, N-ethylmorpholine, 1,2-dipiperi-dinoethane, 1,2-dipyrrolidinoethane, 1,2-dimorpholinoethane, potassium and sodium salts of alcohols, phenols, carboxylic acids, sulphonic acids and combinations thereof. In one embodiment of the present disclosure the polymer is a random polymer and, preferably, at least one randomizer is used in the polymerization reaction.

In one embodiment of the present disclosure the polymer is a random polymer. In one embodiment the polymer is a block-copolymer. For the generation of block copolymers, the polymerization is preferably started with one monomer and subsequently, depending on the size of the blocks to be performed the other (co)monomer(s) are added. The sequence of monomer additions can be adapted depending on which blocks of different monomers are desired to be created. In one embodiment of the present disclosure such a block is created at the beginning or at the end of the polymerization or both.

In one embodiment the polymerization is carried out in the presence of at least one solvent and preferably in solution. Preferred solvents for solution polymerizations include inert aprotic solvents, for example aliphatic hydrocarbons. Specific examples include, but are not limited to, butanes, pentanes, hexanes, heptanes, octanes, decanes and cyclopentane, methylcyclopentane, cyclohexane, methylcyclohexane, ethylcyclohexane, 1,4-dimethylcyclohexane and combinations thereof and including isomers thereof. Further examples include alkenes such as 1-butene or aromatic hydrocarbons such as benzene, toluene, ethylbenzene, xylene, diethylbenzene or propylbenzene and combinations thereof. These solvents can be used individually or as mixtures. Preferred solvents include cyclohexane, methylcyclopentane and n-hexane. The solvents may also be mixed with polar solvents if appropriate.

The polymerization can be carried out by first introducing the (co)monomers and solvent and then starting the polymerization by adding initiator or catalyst. The polymerization may also be carried out in a feed process where the polymerization reactor is filled by adding monomers and solvents. The initiator or catalyst are introduced or added with the monomers and solvent. Variations may be used, such as introducing the solvent in the reactor, adding initiator or catalyst followed by adding the monomers. The polymerization can be carried out in a continuous mode or batchwise. Further monomer and solvent may be added during or at the end of the polymerization.

The polymerization can be carried out at normal pressure or at elevated pressure (for example, from 1 to 10 bar) or at reduced pressure. Typical reaction temperatures include room temperature but depending on the nature and amounts of comonomers the reaction temperature may be above or below room temperature. Typical ranges include, for example from −12° C. to 140° C. in a continuous adiabatic process, or from 50 to 120° C. in a batch process.

The polymerization reaction leads to reactive polymer chain ends, preferably anionic chain ends. The polymerization mixture or solution containing reactive polymer chain ends is contacted with at least one of the siloxane-based coupling agents according to the present disclosure at the desired progression of the polymerization reaction, for example when the desired conversion rate or the desired molecular weight range of the polymer has been reached. Typically, it is desired to carry out the coupling reaction at the end of the polymerization reaction, for example after at least 90%, or at least 95% of the monomers have been consumed. For example, the coupling agent may be added before or after the monomer feed has been stopped or discontinued. The coupling agent may be added as pure substance or as solution or dispersion. Although not preferred and not necessary, coupling agents other than the unsaturated siloxanes according to the present disclosure may be used in addition. Typically, the addition of the coupling agent is carried out at a reaction temperature of 20° C. to 130° C., or from 50° C. to 130° C.

Another advantage of using the siloxane-based coupling agents for producing diene rubber is that the polymers obtained by using them can still be functionalized to produce diene rubbers with additional functional groups, preferably end groups. Therefore, the method according to the present disclosure may further comprises the step reacting the polymer with at least one functionalization agent for introducing at least one functional group to the polymer, wherein this step may be carried out before, after or during step (ii). Typically, such functionalization reagents are aliphatic compounds containing in addition to carbon and hydrogen atoms, heteroatoms selected from Si, O, S and N, preferably combinations of heteroatoms selected from Si and O, combinations of selected from Si, O and S, and combination of Si, O and N, or combinations of N and O. Typically, they lead, either directly or upon hydrolysis or reaction with another functional agent or both, to the polymer having at least one polar group selected from —OH, —COOH, —SH or salts thereof and combinations thereof. Typically, the functionalization agent has a molecular weight of less than 5,000 g/mole or even less than 2,000 g/mole.

Functionalization reagents as known in the art may be used. Examples of functionalization agents include but are not limited to linear or branched alkoxysilanes and those described in US2013/0281605A1, US2013/0338300A1, US2013/0280458A1, US2016/0075809A1, US2016/0083495A1, WO2021/009154A1, U.S. Pat. No. 4,894,409 and WO2021/009156.

Preferred functionalization agents include linear or branched alkoxysilanes, linear or branched silanes and the reagents selected from the group consisting of:

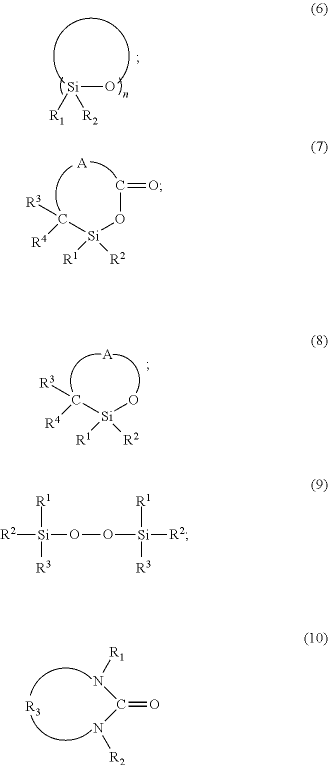

and combinations thereof.

In one embodiment of the present disclosure the functionalization reagent is a linear or branched silane or siloxane. In another embodiment of the present disclosure the functionalization reagent is a cyclic reagent. In one embodiment of the present disclosure the functionalization reagent is cyclic and has a 4- to 7-membered aliphatic cyclic ring, more preferably 5- or 6-membered aliphatic cyclic ring wherein the ring either has at least 2, preferably at least 3 carbon atoms and at least one heteroatom selected from N, O, S, Si or a combination thereof. In another embodiment of the present disclosure the functionalization reagent is cyclic and has a 3- to 20-membered cyclic structure wherein the ring has at least two, preferably at least three —Si(R1R2)-O— units, wherein R1 and R2 are, independently from each other, selected from H, a C₁-C₁₀ saturated hydrocarbon residue that, optionally, may contain one or more heteroatoms selected from O, N, S, Si or a combination thereof. Preferably, R1 and R2 are selected from methyl, ethyl, propyl and butyl.

Functionalization Reagents according to formula (6):

Reagents according to formula (6) include cyclosiloxane-based functionalization reagents. In formula (6) R₁ and R₂ are the same or different and correspond to H, C₁-C₁₀ saturated hydrocarbon residue, preferably methyl, ethyl, propyl and butyl, and wherein the C₁-C₁₀ saturated hydrocarbon residue, optionally, contains one or more heteroatoms selected from O, N, S, Si or a combination thereof, and n is an integer selected from 3 to 10, preferably 4 to 6. Specific examples of reagents according to formula (6) include but are not limited to hexamethylcyclotrisiloxane, octamethylcyclotetrasiloxane, decamethylcyclopentasiloxane and dodecamethylcyclohexasiloxane, Reagents according to formula (6) can lead directly or indirectly (for example via a subsequent hydrolysis) to silanol (—Si(R₁)(R₂)—OH) or silanolate (—Si(R₁)(R₂)—O—) groups) as described, for example in US2016/0075809A1.

Functionalization reagents according to formula (7):
Reagents according to formula (7) include silalactone-based functionalization reagents. In formula (7) R¹ and R² are the same or different and are each selected from H or a residue having from 1 to 20 carbon atoms, preferably selected from alkyls, alkoxys, cycloalkyls, cycloalkoxys, aryls, aryloxys, alkaryls, alkaryloxy, aralkyls, or aralkoxys;
R³, R⁴ are the same or different and are each selected from H or a residue having from 1 to 20 carbon atoms, preferably from alkyl, cycloalkyl, aryl, alkaryl or aralkyl,
A is a divalent organic radical, preferably having from 1 to 26 carbon atoms, and which may, in addition to hydrogen atoms, comprise heteroatoms selected from O, N, S and Si.

Preferably R¹, R² are the same or different and are selected from H, a (C₁-C₂₄)-alkyl, a (C₁-C₂₄)-alkoxy, a (C₃-C₂₄)-cycloalkyl, a (C₃-C₂₄)-cycloalkoxy, a (C₆-C₂₄)-aryl, a (C₆-C₂₄)-aryloxy, a (C₆-C₂₄)-alkaryl, a (C₆-C₂₄)-alkaryloxy, a (C₆-C₂₄)-aralkyl or a (C₆-C₂₄)-aralkoxy radical which, optionally, may contain one or more heteroatoms selected from O, N, S or Si.

Preferably R³, R⁴ are the same or different and are each selected from H, a (C₁-C₂₄)-alkyl, a (C₃-C₂₄)-cycloalkyl, a (C₆-C₂₄)-aryl, a (C₆-C₂₄)-alkaryl or a (C₆-C₂₄)-aralkyl radical, optionally containing one or more heteroatoms, selected from O, N, S or Si.

In one embodiment of the present disclosure A is represented by:

—Xn-(CY1H)m-(CY2Y3)o-(CY1H)p-
where
n is 1 or 0, m is 1, 2, 3 or 4, o is 0, 1 or 2, p is 0, 1 or 2, preferably the sum of n, m, o and
p is 2 or 3;
X is O, S, NR, where R is H or C1-C3 alkyl or X is N(Si(alkyl)₃), wherein each “alkyl” independently from each other represents a C1 to C6 alkyl, -oxyalkyl or alkoxy;
Y1 is H or C1-C3 alkyl, Y2 is H or C1-C3 alkyl, Y3 is H or C1-C3 alkyl, preferably at least one of Y2 and Y3 is H.

Specific, non-limiting-examples of A include:
—CH₂—; —CH₂CH₂—; —CH₂CH₂CH₂—; —C(CH₃)—CH₂—; —CH₂—C(CH₃)—CH—; —CH(CH₃)—C(CH₃)H—; —CH(CH₃)—CH₂—C(CH₃)H—; —CH₂—C(CH₃)H—C(CH₃)H—; —CH(CH₃)—C(CH₃)H—CH₂—; —O—CH₂—; —O—CH₂CH₂—; —O—CH₂CH₂—CH₂—; —O—C(CH₃)H—; —O—CH₂CH₂—; —O—C(CH₃)H—CH₂—; —O—CH₂—C(CH₃)H—; —O—CH₂—C(CH₃)H—CH₂—; —O—CH₂CH₂—C(CH₃)H—; —O—C(CH₃)H—CH₂—CH₂—; —S—CH₂—; —S—CH₂CH₂—; —S—CH₂CH₂—CH₂—; —S—C(CH₃)H—; —S—CH₂CH₂—; —S—C(CH₃)H—CH₂—; —S—CH₂—C(CH₃)H—; —S—CH₂—C(CH₃)H—CH₂—; —S—CH₂CH₂—C(CH₃)H—; —S—C(CH₃)H—CH₂—CH₂—;
—NH—CH₂—; —NH—CH₂CH₂—; —NH—CH₂CH₂—CH₂—; —NH—C(CH₃)H—CH₂—; —NH—CH₂—C(CH₃)H—; —NH—CH₂—C(CH₃)H—CH₂—; —NH—CH₂CH₂—C(CH₃)H—; —NH—C(CH₃)H—CH₂—CH₂—; —N(CH₃)—CH₂—; —N(CH₃)—CH₂—; —N(CH₃)—CH₂CH₂—; —N(CH₃)—CH₂CH₂—CH₂—; —N(CH₃)—C(CH₃)H—CH₂—; —N(CH₃)—CH₂—C(CH₃)H—; —N(CH₃)—CH₂—C(CH₃)H—CH₂—; —N(CH₃)—CH₂CH₂—C(CH₃)H—; —N(CH₃)—C(CH₃)H—CH₂—CH₂—; N(Si(alkyl)₃)—CH₂—; —N(Si(alkyl)₃)—CH₂CH₂—; N(Si(alkyl)₃)—CH₂CH₂CH₂—; —N(Si(alkyl)₃)—C(CH₃)H—; —N(Si(alkyl)₃)—CH₂CH₂—; —N(Si(alkyl)₃)—C(CH₃)H—CH₂—; —N(Si(alkyl)₃)—CH₂—C(CH₃)H—; —N(Si(alkyl)₃)—CH₂—C(CH₃)H—CH₂—; —N(Si(alkyl)₃)—CH₂CH₂—C(CH₃)H—; —N(Si(alkyl)₃)—C(CH₃)H—CH₂—CH₂—.

Examples of reagents according to formula (7) include:
2,2-dimethyl-1-oxa-2-silacyclohexan-6-one, 2,2,4-trimethyl-1-oxa-2-silacyclohexan-6-one, 2,2,5-trimethyl-1-oxa-2-silacyclohexan-6-one, 2,2,4,5-tetramethyl-1-oxa-2-silacyclohexan-6-one, 2,2-diethyl-1-oxa-2-silacyclohexan-8-one, 2,2-diethoxy-1-oxa-2-silacyclohexan-6-one, 2,2-dimethyl-1,4-dioxa-2-silacyclohexan-6-one, 2,2,5-trimethyl-1,4-dioxa-2-silacyclohexan-6-one, 2,2,3,3-tetramethyl-1,4-dioxa-2-silacyclohexan-6-one, 2,2-dimethyl-1-oxa-4-thia-2-silacyclohexan-6-one, 2,2-diethyl-1-oxa-4-thia-2-silacyclohexan-6-one, 2,2-diphenyl-1-oxa-4-thia-2-silacyclonexan-6-one, 2-methyl-2-ethenyl-1-oxa-4-thia-2-silacyclohexan-6-one, 2,2,5-trimethyl-1-oxa-4-thia-2-silacyclohexan-6-one, 2,2-dimethyl-1-oxa-4-aza-2-silacyclohexan-6-one, 2,2,4-trimethyl-1-oxa-4-aza-2-silacyclohexan-6-one, 2,4-dimethyl-2-phenyl-1-oxa-4-aza-2-silacyclohexan-6-one, 2,2-dimethyl-4-trimethylsilyl-1-oxa-4-aza-2-silacyclohexan-8-one, 2,2-diethoxy-4-methyl-1-oxa-4-aza-2-silacyclohexan-6-one, 2,2,4,4-tetramethyl-1-oxa-2,4-disilacyclohexan-8-one, 3,4-dihydro-3,3-dimethyl-1H-2,3-benzoxasilin-1-one, 2,2-dimethyl-1-oxa-2-silacyclopentan-5-one, 2,2,3-trimethyl-1-oxa-2-silacyclopenten-5-one, 2,2-dimethyl-4-phenyl-1-oxa-2-silacyclopentan-5-one, 2,24(tert-butyl)-1-oxa-2-silacyclopentan-5-one, 2-methyl-2-(2-propen-1-yl)-1-oxa-2-silacyclopentan-5-one, 1,1-dimethyl-2,1-benzoxasilol-3(1H)-one, 2,2-dimethyl-1-oxa-2-silacycloheptan-7-one.

Reagents according to formula (7) are described, for example, in US2016/0075809A1, in particular in [0034]-[0042]. The use of such a reagent alone or by adding it to another functionalization reagent, for example a reagent according to formula (6) can lead to the creation of silacarboxylate groups, for example groups according to the general formula —Si(R¹)(R²)—C(R³)(R⁴)-A-COO⁻.

Functionalization reagents according to formula (8):

Reagents according to formula (8) include oxa-silacycloalkanes. In formula (8) R¹, R², R³, R⁴ and A are the same as described for formula (7).

Examples of specific reagents according to formula (8) include:
2,2-dimethyl-1-oxa-2-silacyclohexane, 2,2-diethyl-1-oxa-2-silacyclohexane, 2,2-dipropyl-1-oxa-2-silacyclohexane, 2-methyl-2-phenyl-1-oxa-2-silacyclohexane, 2,2-diphenyl-1-oxa-2-silacyclohexane, 2,2,5,5-tetramethyl-1-oxa-2-silacyclohexane, 2,2,3-trimethyl-1-oxa-2-silacyclohexane, 2,2-di methyl-1-oxa-2-silacyclopentane, 2,2,4-trimethyl-1-oxa-2-silacyclopentane, 2,2-dimethyl-1,4-dioxa-2-silacyclohexane, 2,2,55-tetramethyl-1,4-dioxa-2,5-disilacyclohexane, 2,2,4-trimethyl-1-oxa-4-aza-2-silacyclohexane, benzo-2,2-dimethyl-1,4-dioxa-2-silacyclohexane, benzo-2,2,4-trimethyl-1-oxa-4-aza-2-silacyclohexane. Reagents according to formula (8) are described, for example in US2013/0281605A1. The use of reagents according to formula (8) may lead to carbinol groups corresponding to the formula —S(R¹)(R²)—C(R³)(R⁴)-A-OH.

Functionalization reagents according to formula (9):

The reagents according to formula (9) include bis(trialkylsilyl) peroxides. R¹, R², and R³ can be identical or different and are selected from linear or branched or cyclic alkyls which, optionally, can comprise heteroatoms selected from O, N, S, and Si and a combination thereof. Preferably, they are selected from C1-C10 linear alkyls and preferably they are all identical. Preferably at least one of R¹, R² and R³ is methyl and more preferably all are methyl.

Functionalization reagents according to formula (10):

The reagents according to formula (10) include cyclic ureas. In formula (10) R₃ represents a divalent, saturated or unsaturated, linear or branched, preferably aliphatic, hydrocarbon group having from 1 to 20 carbon atoms which, in addition to C and H, may contain one or more heteroatoms, preferably independently of one another selected from O, N, S or Si. Preferably R₃ corresponds to the general formula (11):

—[CHX¹]ₒ—[CHX²]ₚ—[O]_{z}—[CHX³]_{q} (11)
wherein z is 1 or 0, o, p and q are independently selected from 0, 1 and 2 with the proviso that at least one of o, p and q is not 0. X¹, X² and X³ are independently selected from H and linear or branched alkyl, alkylaryl and aryl groups having from 1 to 12 carbon atoms and from aminoalkyl (N—R) groups wherein R is a linear or branched or cyclic alkyl or alkylaryl residue having from 1 to 12 carbon atoms, and X¹ and X² may represent a chemical bond between to form a carbon-carbon bond to provide an unsaturation in the carbon chain. o, p, q, X¹, X² and X³ are selected such that the total number of carbon atoms is not more than 20.

In one embodiment of the present disclosure R₃ is selected from substituted alkylenes, for example from substituted alkylenes corresponding to formula (11) wherein at least one of X¹, X² and X³ is not H.

In one embodiment of the present disclosure R₃ is selected from unsubstituted alkylenes, for example from unsubstituted alkylenes corresponding to formula (11) wherein all of X¹, X² and X³ are H. In a preferred embodiment R₃ corresponds to —[(CH)₂]ₙ—, wherein n is an integer from 1 to 5, preferably 1 to 3, more preferably 1 or 2.

In one embodiment of the present disclosure R₃ is selected from unsaturated substituted or unsubstituted alkylenes and, for example, corresponds to formula (IIa) wherein X¹ and X² together form a carbon-carbon bond. Specific examples of unsaturated alkylenes include but are not limited to —CH═CH— or —CH₂—CH═CH—.

In formula (10) R₁ and R₂ are identical or different and represent saturated or unsaturated hydrocarbon groups having from 1 to 20 carbon atoms and wherein the hydrocarbon group may contain, in addition to C and H atoms, one or more heteroatoms, preferably selected from the group consisting of O, N, S and Si. For example, R₁ and R₂ may be identical or different and are selected from —(C₁-C₂₀)-alkyl, —(C₃-C₂₀)-cycloalkyl, —(C₆-C₂₀)-aryl, —(C₆-C₂₀)-alkaryl or —(C₆-C₂₀)-aralkyl radicals which may contain one or more heteroatoms, preferably independently selected from O, N, S or Si. Preferably R₁, R₂ are selected independently from each other from methyl, ethyl, n-propyl, isopropyl, n-butyl, sec-butyl, tert-butyl, trialkyl silyl with alkyl groups of 1 to 4 carbon atoms per alkyl group, phenyl and phenyls independently substituted with one, two or three methyl-, ethyl-, propyl, and/or -butyl residues.

Preferred specific examples of agents according to formula (10) include but are not limited to: 1,3-dimethyl-2-imidazolidinone, 1,3-diethyl-2-imidazolidinone, 1-methyl-3-phenyl-2-imidazolidinone, 1,3-diphenyl-2-imidazolidinone, 1,3,4-trimethyl-2-imidazolidinone, 1,3-bis(trimethylsilyl)-2-imidazolidinone, 1,3-dihydro-1,3-dimethyl-2H-imidazol-2-one, tetrahydro-1,3-dimethyl-2(1H)-pyrimidinone, tetrahydro-1-methyl-3-phenyl-2(1H)-pyrimidinone, tetrahydro-1,3,5-trimethyl-2(1H)-pyrimidinone, tetrahydro-3,5-dimethyl-4H-1,3,5-oxadiazin-4-one, tetrahydro-1,3,5-trimethyl-1,3,5-triazin-2(1H)-one, hexahydro-1,3-dimethyl-2H-1,3-diazepin-2-one. A particularly preferred example is 1,3-dimethyl-2-imidazolidinone, also referred to as DMI, i.e. R₃ is —CH₂—CH₂— and/or R₁ and R₂ are both —CH₃.

Reagents according to formula (10) are described, for example, in U.S. Pat. No. 4,894,409, and international patent applications WO2021/009154 and WO2021/009156.

The functionalization reagents described above can react with reactive chain ends of the polymer and are therefore also referred to herein as “omega-functionalization reagents.” Instead of or in addition to adding the omega-functionalization reagents, “alpha-functionalization agents” may be added at the beginning of the polymerization, for example as functionalized initiators. This typically leads to alpha-functionalized polymers, i.e., polymers with polar groups at the beginning of the chain. Examples of alpha-functionalization reagents are described in EP 2847264 A1 and EP 2847242 A1.

In case the polymerization reaction is not terminated by the reaction with the coupling reagent, or by the optional reaction with the one or more omega-functionalization agents described above, the polymerization reaction may be terminated, for example by quenching. Quenching agents known in the art may be used. Typical quenching agents for terminating the polymerization include alcohols, for example octanol.

The polymers may be worked up and isolated as known in the art. Antioxidants as known in the art, such as sterically hindered phenols, aromatic amines, phosphites, thioethers, may be added to the reaction mixture. Preferably they are added before or during the working up of the polymers of the present disclosure. Extender oils used for diene rubbers such as TDAE (Treated Distillate Aromatic Extract)-, MES (Mild Extraction Solvates)-, RAE (Residual Aromatic Extract)-, TRAE (Treated Residual Aromatic Extract)-, naphthenic and heavy naphthenic oils can be added to the reaction mixture prior or during work up for providing oil-extended rubbers. The solvent can be removed from the reaction mixture by conventional methods including distillation, stripping with steam or by applying a vacuum or reduced pressure, if necessary, at elevated temperatures. Typically, the solvent is recycled.

The polymer crumbs can be further dried on mills or processed on mills, for example into sheets, or compressed for example into bales.

### Rubber Compounds

The polymers according to the present disclosure can be used to produce rubber compounds. Rubber compounds can be prepared by a process comprising mixing at least one polymer according to the present disclosure with at least one filler. The rubber compounds may be vulcanizable and further comprise one or more than one curing agent. The curing agent is capable of crosslinking (curing) the diene polymer and is also referred to herein as “crosslinker” or “vulcanization agent”. Suitable curing agents include, but are not limited to, sulfur, sulfur-based compounds, and organic or inorganic peroxides.

In a preferred embodiment of the present disclosure the curing agent includes a sulfur. Instead of a single curing agent a combination of one or more curing agents may be used, or a combination of one or more curing agent with one or more curing accelerator or curing catalysts may be used. Examples of sulfur-containing compounds acting as sulfur-donors include but are not limited to sulfur, sulfur halides, dithiodimorpholine (DTDM), tetramethylthiuramdisulphide (TMTD), tetraethylthiuramdisulphide (TETD), and dipentamethylenthiuramtetrasulphide (DPTT). Examples of curing accelerators include but are not limited to amine derivates, guanidine derivates, aldehydeamine condensation products, thiazoles, thiuram sulphides, dithiocarbamates and thiophospahtes.

In another embodiment of the present disclosure the curing agent includes a peroxide. Examples of peroxides used as vulcanizing agents include but are not limited to di-tert.-butyl-peroxides, di-(tert.-butyl-peroxy-trimethyl-cyclohexane), di-(tert.-butyl-peroxy-isopropyl-)benzene, dichloro-benzoylperoxide, dicumylperoxides, tert.-butyl-cumyl-peroxide, dimethyl-di(tert.-butyl-peroxy)hexane and dimethyl-di(tert.-butyl-peroxy)hexine and butyl-di(tert.-butyl-peroxy)valerate. A vulcanizing accelerator of sulfene amide-type, guanidine-type, or thiuram-type can be used together with a vulcanizing agent as required.

If added, the vulcanizing agent is typically present in an amount of from 0.5 to 10 parts by weight, preferably of from 1 to 6 parts by weight per 100 parts by weight of rubber.

The rubber compounds are suitable for making tires or components of tires such as sidewalls or tire treads. The tire or tire component will typically contain the rubber compound in is vulcanized form.

Conventional fillers can be used. Conventional fillers include silicas and carbon-based fillers, for example carbon blacks. The fillers can be used alone or in a mixture. In a particularly preferred form, the rubber compositions contain a mixture of silica fillers and carbon black. The weight ratio of silica fillers to carbon black may be from 0.01:1 to 50:1, preferably from 0.05:1 to 20:1.

Preferably, the filler includes silica-containing particles, preferably having a BET surface area (nitrogen absorption) of from 5 to 1,000, preferably from 20 to 400 m²/g. Such fillers may be obtained, for example, by precipitation from solutions of silicates or by flame hydrolysis of silicon halides. Silica-containing filler particles may have particle sizes of 10 to 400 nm. The silica-containing filler may also contain oxides of Al, Mg, Ca, Ba, Zn, Zr or Ti. Other examples of silicon-oxide based fillers include aluminum silicates, alkaline earth metal silicates such as magnesium silicates or calcium silicates, preferably with BET surface areas of 20 to 400 m²/g and primary particle diameters of 10 to 400 nm,
natural silicates, such as kaolin and other naturally occurring silicates including clay (layered silicas). Further examples of fillers include glass particle-based fillers like glass beads, microspheres, glass fibers and glass fiber products (mats, strands).

Polar fillers, like silica-containing fillers, may be modified to make them more hydrophobic. Suitable modification agents include silanes or silane-based compounds. Typical examples of such modifying agents include, but are not limited to compounds corresponding to the general formula (7):

(R¹R²R³O)₃Si—R⁴—X (7)
wherein each R¹, R², R³ is, independently from each other, an alkyl group, preferably R¹,R²,R³ are all methyl or all ethyl, R⁴ is an aliphatic or aromatic linking group with 1 to 20 carbon atoms and X is sulfur-containing functional group and is selected from —SH, —SCN, —C(═O)S or a polysulfide group.

Instead of or in addition to silicas that have been modified as described above such modification may also take place in situ, for example during compounding or during the process of making tires or components thereof, for example by adding modifiers, preferably silanes or silane-based modifiers, for example including those according to formula (7), when making the rubber compounds.

Filler based on metal oxides other than silicon oxides include but are not limited to zinc oxides, calcium oxides, magnesium oxides, aluminum oxides and combinations thereof. Other fillers include metal carbonates, such as magnesium carbonates, calcium carbonates, zinc carbonates and combinations thereof, metal hydroxides, e.g. aluminum hydroxide, magnesium hydroxide and combinations thereof, salts of alpha-beta-unsaturated fatty acids and acrylic or methacrylic acids having from 3 to 8 carbon atoms including zinc acrylates, zinc diacrylates, zinc methacrylates, zinc dimethacrylates and mixtures thereof.

In another embodiment of the present disclosure the rubber compound contains one or more fillers based on carbon, for example one or more carbon black. The carbon blacks may be produced, for example, by the lamp-black process, the furnace-black process or the gas-black process. Preferably, the carbon back has a BET surface area (nitrogen absorption) of 20 to 200 m²/g. Suitable examples include but are not limited to SAF, ISAF, HAF, FEF and GPF blacks.

Other examples of suitable filler include carbon-silica dual-phase filler, lignin or lignin-based materials, starch or starch-based materials and combinations thereof.

In a preferred embodiment, the filler comprises one or more silicon oxide, carbon black or a combination thereof.

Typical amounts of filler include from 5 to 200 parts per hundred parts of rubber, for example, from 10 to 150 parts by weight, or from 10 to 95 parts by weight for 100 parts by weight of rubber.

The rubber compounds may further contain one or more additional rubbers other than the diene rubbers according to the present disclosure and one or more than one rubber additive. Additional rubbers include, for example, natural rubber and synthetic rubber. If present, they may be used in amounts in the range from 0.5 to 95% by weight, preferably in the range from 10 to 80% by weight, based on the total amount of rubber in the composition. Examples of suitable synthetic rubbers include BR (polybutadiene), acrylic acid alkyl ester copolymers, IR (polyisoprene), E-SBR (styrene-butadiene copolymers produced by emulsion polymerization), S—SBR (styrene-butadiene copolymers produced by solution polymerization), IlR (isobutylene-isoprene copolymers), NBR (butadiene-acrylonitrile copolymers), HNBR (partially or completely hydrogenated NBR rubber), EPDM (ethylene-propylene-diene terpolymers) and mixtures thereof. Natural rubber, E-SBR and S—SBR with a glass temperature above −60° C., polybutadiene rubber with a high cis content (>90%) produced with catalysts based on Ni, Co, Ti or Nd, polybutadiene rubber with a vinyl content of up to 80% and mixtures thereof are of particular interest for the manufacture of automotive tires.

The rubber compounds may also comprise one or more rubber additive. Rubber additives are ingredients that may improve the processing properties of the rubber compositions, serve to crosslink the rubber compositions, improve the physical properties of the vulcanizates produced from the rubber, improve the interaction between the rubber and the filler or serve to bond the rubber to the filler. Rubber auxiliaries include, but are not limited to reaction accelerators, antioxidants, heat stabilizers, light stabilizers, ozone stabilizers, processing aids, plasticizers, tackifiers, blowing agents, dyes, pigments, waxes, extenders, organic acids, silanes, retarders, metal oxides, extender oils such as DAE (Distillate Aromatic Extract)-, TDAE (Treated Distillate Aromatic Extract)-, MES (Mild Extraction Solvates)-, RAE (Residual Aromatic Extract)-, TRAE (Treated Residual Aromatic Extract)-, naphthenic and heavy naphthenic oils as well as activators.

The total amount of rubber additives may range from 1 to 300 parts by weight, preferably from 5 to 150 parts by weight based on 100 parts by weight of total rubber in the composition.

The rubber compositions can be prepared with conventional processing equipment for making and processing of (vulcanizable) rubber compounds and include rollers, kneaders, internal mixers or mixing extruders. The rubber compositions can be produced in a single-stage or a multi-stage process, with 2 to 3 mixing stages being preferred. Cross-linking agents, for example sulfur, and accelerators may be added in a separate mixing stage, for example on a roller, with temperatures in the range of 30° C. to 90° C. being preferred. Cross-linking agent, for example sulfur, and accelerator are preferably added in the final mixing stage.

### Applications

The rubber compositions according to the present disclosure can be used for producing rubber vulcanizates, in particular for producing tires, in particular tire treads.

Rubber vulcanizates can be obtained by providing a vucanizable composition according to the present disclosure and subjecting it to at least one curing reaction. The vulcanizable and/or the vulcanized rubber composition can be subjected to shaping prior, during or after the curing reaction. Shaping may be carried out by process steps including molding, extruding and a combination thereof.

The (vulcanizable) rubber compositions provided herein are also suitable for the manufacture of molded articles, for example for the manufacture of cable sheaths, hoses, drive belts, conveyor belts, roll linings, shoe soles, sealing rings and damping elements.

Another aspect of the present disclosure relates to a molded article, in particular a component of a tire, for example a tire tread, or a complete tire, containing a vulcanized rubber composition obtained by vulcanizing a vulcanizable rubber composition according to the present disclosure.

The following examples are provided to further illustrate the present disclosure without, however, intending to limit the disclosure to the embodiments set forth in these examples.

### EXAMPLES

### Methods

The number-average molecular weight Mn, the weight average molecular weight, the dispersity Ð=Mw/Mn (also referred to herein as molecular weight distribution or MWD) and the degree of coupling of the polymers were determined using gel permeation chromatography (GPC) at 35° C. (THF as solvent and polystyrene calibration).

The Mooney viscosity was measured according to DIN ISO 289-1 (2018) at the measuring conditions ML (1+4) at 100° C. Mooney Stress Relaxation (MSR) was determined from the same measurement according to ASTM D 1646-00.

Dynamic properties of vulcanized compounds were determined according to DIN53513-1990 on Eplexor 500 N from Gabo-Testanlagen GmbH, Ahlden, Germany at 10 Hz in the temperature range from −100° C. to +100° C. at a heating rate of 1 K/min (Sample: strips with l*w*t=60 mm*10 mm*2 mm; free length between sample holder 30 mm). The following properties can be determined this way: tan δ (60° C.), i.e. the loss factor (E″/E′) at 60° C.; and tan δ (0° C.), i.e. the loss factor (E″/E′) at 0° C. tan δ (60° C.) is a measure of hysteresis loss from the tire under operating conditions. As tan δ (60° C.) decreases, the rolling resistance of the tire decreases. tan δ (0° C.) is a measure for the wet grip of the material. As tan δ (0° C.) increases the wet grip increases.

Elastic properties were determined according to DIN53513-1990. An elastomer test system (MTS Systems GmbH, 831 Elastomer Test System) was used. The measurements were carried out in double shear mode with no static pre-strain in shear direction and oscillation around 0 on cylindrical samples (2 samples each 20×6 mm, pre-compressed to 5 mm thickness) and a measurement frequency of 10 Hz in the strain range from 0.1 to 40%. The method was used to obtain the following properties:

G′ (0.5%): dynamic modulus at 0.5% amplitude sweep, G′ (15%): dynamic modulus at 15% amplitude sweep, G′ (0.5%)−G′ (15%): difference of dynamic modulus at 0.5% relative to 15% amplitude sweep, tan δ (max): maximum loss factor (G″/G′) of entire measuring range at 60° C.

The difference of G′ (0.5%)−G′ (15%) is an indication of the Payne effect of the mixture.

The lower the value the better the distribution of the filler in the mixture, the better the rubber-filler interaction. Tan δ (max) is another measure of the hysteresis loss from the tire under operating conditions. As tan δ (max) decreases, the rolling resistance of the tire decreases.

The rebound elasticity was determined at 60° C. according to DIN 53512.

### Polymers

### Example 1 (Comparative)

An inert 20 L reactor was filled with 8500 g hexane, 1500 g 1,3-butadiene and 10 mmol n-butyllithium (as a 23 wt. % solution in hexane) and stirred at 70° C. for 45 min. The polymer solution was quenched with 10 mmol n-octanol, stabilized with 4.5 g Irganox®1520 (2,4-bis(octylthiomethyl)-6-methylphenol), precipitated in ethanol and dried in a vacuum oven at 65° C.

This reference example shows a general procedure for producing diene polymers. Copolymers of one or more conjugated dienes with one or mor vinyl aromatic monomers, including styrenes can be prepared in the same way.

### Example 1a (Comparative)

An inert 20 L reactor was filled with 8500 g hexane, 1500 g 1,3-butadiene and 16 mmol n-butyllithium (as a 23 wt. % solution in hexane) and stirred at 70° C. for 45 min. 2.56 mmol SiCl₄ was added and stirred for 30 min. The polymer solution was quenched with 16 mmol n-octanol, stabilized with 7.5 g Irganox®1520 (2,4-bis(octylthiomethyl)-6-methylphenol). The solvent was removed by steam stripping and the polymer was dried in a vacuum oven at 65° C. The Mooney viscosity (ML (1+4)@100° C.) was measured to be 83 MU.

### Example 2 (Comparative)

An inert 20 L reactor was filled with 8500 g hexane, 1500 g 1,3-butadiene and 14.25 mmol n-butyllithium (as a 23 wt. % solution in hexane) and stirred at 70° C. for 45 min. 7.125 mmol 2,2-bis(2-tetrahydrofuryl)-propane was added to the living polymer solution and stirred for 5 min. 1.924 mmol SiCl₄ was added and stirred for 5 min. 8.55 mmol octamethylcyclotetrasiloxane was added and stirred for 15 min. 8.55 mmol 2,2-dimethyl-1-oxa-4-thia-2-silacyclohexan-6-one were added. The polymer solution reaction mixture was continued to be stirred for 20 min and was quenched with 14.25 mmol n-octanol and stabilized with 7.5 g Irganox®1520 (2,4-bis(octylthiomethyl)-6-methylphenol). 2 phr stearic acid was added and the solvent was removed by steam stripping. The polymer was dried in a vacuum oven at 65° C.

### Example 3

Example 1 was repeated except that 16 mmol of n-BuLi was used and that after the reaction was stirred for 45 min 8 mmol of 1,3,5,7-tetravinyl-1,3,5,7-tetramethylcyclotetrasiloxane were added to the polymer solution and the polymer solution was stirred for another 20 min.

### Example 4

An inert 20 L reactor was filled with 8500 g hexane, 1500 g 1,3-butadiene and 16 mmol n-butyllithium (as a 23 wt. % solution in hexane) and stirred at 70° C. for 45 min. 8 mmol 1,3,5,7-tetravinyl-1,3,5,7-tetramethylcyclotetrasiloxane was added and stirred for 20 min. 8 mmol of 2,2-dimethyl-1-oxa-4-thia-2-silacyclohexan-6-one were added and the reaction mixture was stirred for another 20 min. The polymer solution was quenched with 16 mmol n-octanol and stabilized with 7.5 g Irganox®1520 (2,4-bis(octylthiomethyl)-6-methylphenol). The solvent was removed by steam stripping and the polymer was dried in a vacuum oven at 65° C.

### Example 5

An inert 20 L reactor was filled with 8500 g hexane, 1500 g 1,3-butadiene and 15.7 mmol n-butyllithium (as a 23 wt. % solution in hexane) and stirred at 70° C. for 45 min. 15.7 mmol of 1,3,5,7-tetravinyl-1,3,5,7-tetramethylcyclotetrasiloxane were added to the polymer solution and the solution was stirred for 20 min. 15.7 mmol 2,2,4-trimethyl-1-oxa-4-aza-2-silacyclohexane were added and the reaction mixture was stirred for another 20 min. The polymer solution was quenched with 16 mmol n-octanol and stabilized with 7.5 g Irganox® 1520 (2,4-bis(octylthiomethyl)-6-methylphenol). The polymer was isolated and dried as described in example 1.

### Example 6

An inert 20 L reactor was filled with 8500 g hexane, 1500 g 1,3-butadiene and 14.25 mmol n-butyllithium (as a 23 wt. % solution in hexane) and stirred at 70° C. for 60 min. 7.125 mmol 2,2-bis(2-tetrahydrofuryl)-propane was added to the living polymer solution and stirred for 5 min. 14.25 mmol 1,3,5,7-tetravinyl-1,3,5,7-tetramethylcyclotetrasiloxane was added and stirred for 15 min. 14.25 mmol 2,2-dimethyl-1-oxa-4-thia-2-silacyclohexan-6-one were added and the reaction mixture was stirred for another 20 min. The polymer solution was quenched with 14.25 mmol n-octanol and stabilized with 7.5 g Irganox®1520 (2,4-bis(octylthiomethyl)-6-methylphenol). 2 phr stearic acid were added before the solvent was removed by steam stripping and the polymer was dried in a vacuum oven at 65° C.

### Example 7 (not Claimed)

An inert 20 L reactor was filled with 8500 g hexane, 1500 g 1,3-butadiene and 15 mmol n-butyllithium (as a 23 wt. % solution in hexane) and stirred at 70° C. for 60 min. 7.5 mmol 2,2-bis(2-tetrahydrofuryl)-propane were added to the living polymer solution and the reaction mixture was stirred for 5 min. 0.525 mmol octavinyloctasilasesquioxane (POSS-Octavinyl substituted, from Sigma Aldrich) was added and the reaction mixture was stirred for 5 min. 11 mmol octamethylcyclotetrasiloxane was added and stirred for 15 min. 11 mmol 2,2-dimethyl-1-oxa-4-thia-2-silacyclohexan-6-one were added and the polymer solution was stirred for another 20 min. The polymer solution was quenched with 15 mmol n-octanol, stabilized with 7.5 g Irganox®1520 (2,4-bis(octylthiomethyl)-6-methylphenol). The work up was as in example 6.

### Example 8

An inert 20 L reactor was filled with 8500 g hexane, 1500 g 1,3-butadiene and 14.25 mmol n-butyllithium (as a 23 wt. % solution in hexane) and stirred at 70° C. for 60 min. 7.125 mmol 2,2-bis(2-tetrahydrofuryl)-propane was added to the living polymer solution and stirred for 5 min. 1.14 mmol 1,3,5,7-tetravinyl-1,3,5,7-tetramethylcyclotetrasiloxane was added and stirred for 5 min. 10.83 mmol octamethylcyclotetrasiloxane was added and stirred for 15 min. 10.83 mmol 2,2-dimethyl-1-oxa-4-thia-2-silacyclohexan-6-one were added and the reaction mixture was stirred for another 20 min. The polymer solution was quenched with 14.25 mmol n-octanol and stabilized with 7.5 g Irganox®1520 (2,4-bis(octylthiomethyl)-6-methylphenol). 2 phr stearic acid were added before the solvent was removed by steam stripping and the polymer was dried in a vacuum oven at 65° C.

TABLE 1
Characterization of the polymers obtained in examples 1 to 8

| | Examples | | | | | | | |
|---|---|---|---|---|---|---|---|---|
| | (comparative) | | Examples | | | | | |
| | 1 | 2 | 3 | 4 | 5 | 6 | 7 | 8 |
| Mₙ / kg mol⁻¹ | 361 | 389 | 406 | 396 | 337 | 299 | 384 | 319 |
| Ð | 1.17 | 1.51 | 1.44 | 1.49 | 1.46 | 1.48 | 1.88 | 1.56 |
| Degree of | — | 56 | 80 | 80 | 64 | 55 | 53 | 43 |
| coupling / % | | | | | | | | |
| ML1 + 4@100° C./ | 62 | 69 | 82 | 82 | 56 | 56 | 62 | 43 |
| MU | | | | | | | | |
| MSR | 1.293 | 0.673 | 0.635 | 0.692 | 0.761 | 0.816 | 0.694 | 0.723 |

Examples 3 to 8 demonstrate that the unsaturated siloxanes according to the present disclosure can be used to prepare coupled polymers. The polymers are coupled as demonstrated by the coupling degrees and low MSR values. The polymers prepared with unsaturated siloxanes according to the present disclosure can also be reacted with different functionalisation reagents as demonstrated by examples 4 to 8.

### Compound Studies

It is known that diene rubbers that are functionalized with polar functional group can improve the dispersion of fillers in tire compounds. In tire compounds rubbers and fillers are the major components and better dispersion of filler in the rubber matrix can ultimately lead to improved tire properties. Rubber compounds containing functionalized diene rubbers are typically more challenging to process than their unfunctionalized counterparts. It was found that the polymers obtained with the unsaturated siloxane-based coupling agents according to the present disclosure may also be used for making tire components and may even lead to compounds having improved filler interactions.

### Examples 9-16

Rubber compositions (examples 9-16) comprising diene rubbers obtained in examples 1, 1A, 2, 3, 6, 7 and 8 were prepared in a 1.5 L kneader with the ingredients shown in table 3 using the mixing protocol shown in table 2. The resulting compositions were vulcanized at 160° C. for 30 min. The properties of the vulcanizates are summarized in tables 3 and 3A.

TABLE 2
Mixing protocol.

| | | |
|---|---|---|
| Step 1: Mixing in | 0 s | Addition of polymers |
| a 1.5 L kneader | 30 s | Addition of 2/3 silica, 2/3 silane, stabilizers, |
| | | stearic acid |
| | 90 s | Addition of 1/3 silica, 1/3 silane, oil, CB |
| | 150 s | Addition of ZnO |
| | 210 s | Heat up to 150° C. and hold for 3 min |

| | |
|---|---|
| Step 2: Mill | 3 × r/l cross-cutting and folding, 3 × end roll (4 mm) |
| Step 3: Storage | 24 h |
| Step 4: Mixing in | Heat up to 150° C. and hold at temperature for 3 min |
| a 1.5 L kneader | |
| Step 5: Mill | 3 × r/l cross-cutting and folding (4 mm) |
| | Sulfur, accelerators |
| | 3 × r/l cross-cutting and folding, 5 × end roll (4 mm) |

TABLE 3
Compound recipes and test results

| | CEx 9 | CEx 10 | Ex 11 | Ex 12** | Ex 13 |
|---|---|---|---|---|---|
| Polymer of Ex 1 | 38 | | | | |
| Polymer of Ex 2 | | 38 | | | |
| Polymer of Ex 6 | | | 38 | | |
| Polymer of Ex 7 | | | | 38 | |
| Polymer of Ex 8 | | | | | 38 |
| Non-functionalized styrene- | 85.25 | 85.25 | 85.25 | 85.25 | 85.25 |
| butadiene polymer (VSL 4526- | | | | | |
| 2HM from ARLANXEO | | | | | |
| Deutschland GmbH) | | | | | |
| ULTRASIL 7000 GR (silica) | 90 | 90 | 90 | 90 | 90 |
| N375 (carbon black) | 5 | 5 | 5 | 5 | 5 |
| VIVATEC 500 | 7.75 | 7.75 | 7.75 | 7.75 | 7.75 |
| AFLUX 37 | 3 | 3 | 3 | 3 | 3 |
| VULKANOX 4020/LG | 2 | 2 | 2 | 2 | 2 |
| VULKANOX HS/LG | 2 | 2 | 2 | 2 | 2 |
| ANTILUX 654 | 2 | 2 | 2 | 2 | 2 |
| SI 69 | 7.2 | 7.2 | 7.2 | 7.2 | 7.2 |
| SULPHUR 90/95 | 1.7 | 1.7 | 1.7 | 1.7 | 1.7 |
| RHENOGRAN ZnO-80 | 3.75 | 3.75 | 3.75 | 3.75 | 3.75 |
| EDENEOR C 18 98-100 | 1 | 1 | 1 | 1 | 1 |
| RHENOGRAN DPG-80 | 2.5 | 2.5 | 2.5 | 2.5 | 2.5 |
| RHENOGRAN TBBS-80 | 2 | 2 | 2 | 2 | 2 |
| Compound Mooney viscosity* | 100 | 113 | 121 | 114 | 120 |
| Rebound at 60° C. * | 100 | 104 | 111 | 106 | 107 |
| tan δ maximum (MTS amplitude | 100 | 106 | 110 | 112 | 109 |
| sweep, 1 Hz, 60° C.)* | | | | | |
| G′ (0.5%)-G′ (15%) * | 100 | 130 | 143 | 160 | 151 |
| tan δ at 0° C. (Eplexor, 10 Hz) * | 100 | 94 | 99 | 101 | 94 |
| tan δ at 60° C. (Eplexor, 10 Hz) * | 100 | 105 | 108 | 107 | 108 |

* The test results in table 3 are shown as index values relative to the value obtained for reference example 9 (made with reference polymer 1). A higher index value means the respective property has improved over the reference example. The index values for compound Mooney viscosity, tan δ maximum and tan δ at 60° C. were calculated as: [(value obtained for reference example 9)/(value of example)] × 100. The index values for rebound at 60° C. and tan δ at 0° C. were calculated as [(value of example)/(value obtained for reference example 9)] × 100.
**= not claimed; EX = example, CEx = comparative example.

The results show that polymers obtained with unsaturated siloxanes according to the invention (examples 11-13) had an improved compound Mooney viscosity compared to reference polymers 1 and 2 (comparative example 9 and 10), which indicates better processability. Examples 11 to 13 had excellent filler dispersion as indicated by an improved Payne effect index (lower [G′ (0.5%)−G′ (15%)]) and improved rolling resistance indicators (rebound 60° C., tan δ maximum and tan delta at 60° C.) compared to the reference polymers. The wet grip performance (tan δ at 0° C.) was similar to that of the reference polymers.

TABLE 3a
Compound properties of compounds made with polymer
of example 1A (comparative example 14) und example 3
(example 15). The test results in table 3A are shown as
index value as explained above for table 3.

| | Comparative | |
|---|---|---|
| | Example 14 | Example 15 |
| Compound Mooney viscosity | 100 | 100 |
| Rebound at 60° C. | 100 | 102 |
| tan δ maximum (MTS | 100 | 114 |
| amplitude sweep, 1 Hz, 60° C.) | | |
| G′ (0.5%)-G′ (15%) | 100 | 114 |
| tan δ at 0° C. (Eplexor, 10 Hz) | 100 | 100 |
| tan δ at 60° C. (Eplexor, 10 Hz) | 100 | 108 |

The results show the improvement of properties of a polymer modified with the siloxane coupling agent according to the present disclosure compared to the known coupling agent SiCl₄.

### Example 16 (Comparative)

A moisture-free and nitrogen-flushed reactor was charged with hexane, butadiene, styrene and 22.9 mmol DTHFP. The reaction mixture was heated to 33° C. and polymerized for 70 min after addition of BuLi (T Max 72.8° C.). Octamethylcyclotetrasiloxane and tetrachlorosilane were added and reacted for 10 min at 70° C. 2,2-dimethyl-[1,4,2]oxathiasilinan-6-one were added an reacted for 30 min. Then the reaction was terminated and stabilized with IRGANOX 1520. The polymer isolated by steam-stripping and drying at 60° C. under reduced pressure.

### Example 17

A moisture free and nitrogen flushed 20 L reactor was charged with 8500 g Hexane, 165 g Styrene, 1335 g Butadiene and 2.39 mmol DTHFP. The reaction mixture was heated to 47.5° C. and adiabatic polymerization is initiated by addition of 14 mmol BuLi and reacted for 60 min (T Max 70° C.). Thereafter, 3.5 mmol 1,3,5,7-Tetravinyl-1,3,5,7-tetramethylcyclotetrasiloxane is added and reacted for 10 min at 70° C. In the next step, 14 mmol 2,2-Dimethyl-[1,4,2]oxathiasilinan-6-one is added and reacted for 10 min at 70° C. The reaction is terminated by addition of 14 mmol 1-octanol and stabilized with Irganox 1520. The polymer is obtained by steam-stripping of the polymer cement and drying at 60° C. under reduced pressure.

TABLE 4
Characterization of the polymers obtained in examples 16 and 17.

| | Mn/kg mol⁻¹ | PDI | MV | Tg/° C. | styrene/% wt |
|---|---|---|---|---|---|
| Example 16 | 341 | 1.6 | 92 | −59 | 11 |
| (comparative) | | | | | |
| Example 17 | 370 | 1.6 | 78 | −60 | 11 |

MV = ML1 + 4 @ 100° C./MU;
PDI = Mw/Mn

Compounds were prepared with ingredients and amounts as described in table 3 except that 100 phr of coupled polymers were used and no VSL 4526-2HM. The compounds were prepared according to the protocol described above.

TABLE 5
Properties of compounds

| | Example 16 | |
|---|---|---|
| | (comparative) | Example 17 |
| Compound Mooney viscosity | 97 | 67 |
| Rebound at 60° C. | 59 | 62 |
| tan δ maximum (MTS | 0.176 | 0.164 |
| amplitude sweep, 1 Hz, 60° C.) | | |
| G′ (0.5%)-G′ (15%) | 2.08 | 1.77 |
| tan δ at 0° C. (Eplexor, 10 Hz) | 0.162 | 0.177 |
| tan δ at 60° C. (Eplexor, 10 Hz) | 0.098 | 0.087 |

The results shown in table 5 demonstrate that coupling with a coupling agent according to the present disclosure also improves the properties of styrene-butadiene copolymers: The decrease of Mooney viscosity and G′(0.5%)−G′(15%) values indicate easier processing and improved rubber-filler interaction (Payne-effect). Rolling resistance indicators also improved (increased rebound and decreased tan delta at 60° C.). Wet grip properties improved indicated by an increased tan delta at 0° C.

1. Method of making a polydiene rubber comprising
(i) polymerizing at least one aliphatic conjugated diene monomer, preferably having from 4 to 25 carbon atoms, to produce a polymer having reactive polymer chain ends,
(ii) reacting at least some of the reactive polymer chain ends with a coupling agent comprising from 2 to 20 unsaturated siloxane units, or from 3 to 10 units, wherein the coupling agent comprises a cyclic structure having at least two unsatured siloxane units but wherein the coupling agent is not polycyclic.

2. The method according to claim 1 wherein the unsaturated siloxane unit comprises at least one alkenyl group.

3. The method according to claim 1 wherein the unsaturated siloxane unit of the coupling agent corresponds to formula (1), 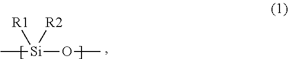
wherein R1 represents an alkenyl and wherein each R2 independently represents H, OH or an organic residue having from 1 to 20 carbon atoms and, optionally, one or more heteroatom selected from O, N, Si, S and a combination thereof.

4. The method according to claim 3, wherein each R2 independently represents H, OH, an alkenyl having from 2 to 10 carbon atoms, an alkyl having from 1 to 10 carbon atoms, wherein the alkyl or alkenyl chain or both may be interrupted once or more than once by an ether oxygen atom, or a siloxane or polysiloxane with up to 10 silicon atoms wherein the siloxane or polysiloxane, optionally, has at least one silicone atom having at least one aliphatic substituent selected from alkyl or alkenyl groups or a combination thereof, or at least one R2 is methyl, or all residues R2 are either methyl or ethyl or a combination thereof.

5. The method of claim 1, wherein the unsaturated siloxane unit of the coupling agent corresponds to the formula (2): 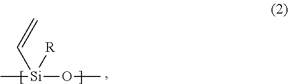
wherein each R independently represents H, OH or an organic residue having from 1 to 20 carbon atoms and, optionally, one or more heteroatom selected from O, N, Si, S, and a combination thereof.

6. The method of claim 5, wherein R represents H, OH, an alkenyl having from 2 to 10 carbon atoms, an alkyl having from 1 to 10 carbon atoms, wherein the alkyl or alkenyl chain or both may be interrupted once or more than once by an ether oxygen atom, or a siloxane or polysiloxane with up to 10 silicon atoms wherein the siloxane or polysiloxane, optionally, has at least one silicone atom having at least one aliphatic substituent selected from alkyl or alkenyl groups or a combination thereof, or at least one R is methyl, or all residues R are either methyl or ethyl or a combination thereof.

7. The method according to claim 1, wherein the coupling agent has a cyclic structure comprising at least three of the unsaturated siloxane units.

8. The method according to claim 1, wherein the coupling agent corresponds to formula (3) 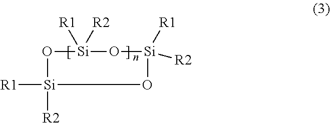
wherein n is an integer of 1 to 5, or 1 to 3, and R1 represents an alkenyl and each R2 independently represents H, OH or an organic residue having from 1 to 20 carbon atoms and, optionally, one or more heteroatom selected from O, N, Si, S and a combination thereof, or R1 is vinyl and each R2 is selected independently from a C₁-C₇-alkyl, or is methyl.

9. The method according to claim 1, wherein the coupling agent has a molecular weight of less than 5000 g/mol, or less than 2000 g/mol.

10. The method according to claim 1, wherein the conjugated diene monomer is 1,3-butadiene.

11. The method according to claim 1, wherein step (i) comprises copolymerizing one or more copolymerizable vinylaromatic comonomers.

12. The method according to claim 1, wherein the process further comprises before, after or during step (ii), reacting the polymer with at least one functionalisation agent for introducing at least one functional group to the polymer, wherein the functional group has in addition to C and H atoms at least one heteroatom selected from Si, S, N, O and combinations thereof.

13. The method according to claim 1, further comprising at least one of the following steps: terminating the polymerization reaction, adding a stabilizer and/or an oil, isolating the polymer, shaping the polymer into bales, granules or powders.

14. A polydiene rubber obtained by the method according to claim 1.

15. A curable composition comprising a polydiene rubber obtained by the method according to claim 1 and further comprising at least one vulcanisation agent for curing the polydiene rubber, optionally comprising the vulcanisation agent in an amount of from 0.5 to 10 parts by weight per 100 parts by weight of diene rubber.

16. A composition comprising a cured polydiene rubber obtained by curing a curable composition comprising a polydiene rubber obtained by the method according to claim 1.

17. The method according to claim 1 wherein the unsaturated siloxane unit comprises at least one alkenyl group selected from the group consisting of vinyl (—CH═CH₂), allyl (—CH₂—CH═CH₂), n-butenyl (—CH₂CH₂CH═CH₂), isobutenyl (—CH₂(CH₃)CH═CH₂), n-pentenyl (—CH₂CH₂CH₂CH═CH₂), isopentenyl (—CH₂(CH₃)CH₂CH═CH₂, —CH₂CH₂(CH₃)CH═CH₂) or a combination thereof.

18. The method according to claim 1 wherein the unsaturated siloxane unit of the coupling agent corresponds to formula (1), 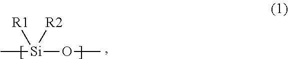
wherein R1 represents an alkenyl selected from the group consisting of vinyl (—CH═CH₂), allyl (—CH₂—CH═CH₂), n-butenyl (—CH₂CH₂CH═CH₂), isobutenyl (—CH₂(CH₃)CH═CH₂), n-pentenyl (—CH₂CH₂CH₂CH═CH₂), isopentenyl (—CH₂(CH₃)CH₂CH═CH₂, —CH₂CH₂(CH₃)CH═CH₂) and wherein each R2 independently represents H, OH or an organic residue having from 1 to 20 carbon atoms and, optionally, one or more heteroatom selected from O, N, Si, S and a combination thereof.

19. The method according to claim 1, wherein step (i) comprises copolymerizing one or more copolymerizable vinylaromatic comonomers selected from styrene, ortho-methyl styrene, meta-methyl styrene, para-methyl styrene, para-tertbutyl styrene and combinations thereof.

20. A composition comprising a cured polydiene rubber obtained by curing a curable composition comprising a polydiene rubber obtained by the method according to claim 1, wherein the composition is an article selected from a tire or a tire tread.
